(19) United States
(12) Patent Application Publication
(10) Pub. No.: US 2014/0139915 A1
(43) Pub. Date: May 22, 2014

(54) IMAGE DISPLAY APPARATUS

(71) Applicants: Yuichi Sato, Osaka-shi (JP); Kenji Maeda, Osaka-shi (JP); Masayuki Natsumi, Osaka-shi (JP); Tatsuo Watanabe, Osaka-shi (JP); Kazuya Takayama, Osaka-shi (JP); Takashi Yasumoto, Osaka-shi (JP); Yoshimitsu Inamori, Osaka-shi (JP)

(72) Inventors: Yuichi Sato, Osaka-shi (JP); Kenji Maeda, Osaka-shi (JP); Masayuki Natsumi, Osaka-shi (JP); Tatsuo Watanabe, Osaka-shi (JP); Kazuya Takayama, Osaka-shi (JP); Takashi Yasumoto, Osaka-shi (JP); Yoshimitsu Inamori, Osaka-shi (JP)

(73) Assignee: SHARP KABUSHIKI KAISHA, Osaka-shi, Osaka (JP)

(21) Appl. No.: 14/131,169

(22) PCT Filed: Jul. 6, 2012
(86) PCT No.: PCT/JP2012/067378

§ 371 Date: Jan. 6, 2014

(30) Foreign Application Priority Data
Jul. 7, 2011 (JP) 2011-150941

(51) Int. Cl. G02B 27/22

(52) U.S. Cl. CPC G02B 27/2214
USPC 359/463; 359/462

(57) ABSTRACT

An image display apparatus having sub-pixels of four colors is provided in which the resolution when an image is two-dimensionally displayed is not affected, and deterioration in the color balance of a three-dimensionally displayed image is suppressed. In the image display apparatus, the arrangement of a sub-pixel for displaying red for a left eye and a sub-pixel for displaying green for a right eye has been replaced with the arrangement of a sub-pixel (Lg1) for displaying green for the left eye and a sub-pixel (Rr1) for displaying red for the right eye. The arrangement of a sub-pixel for displaying blue for the left eye and a sub-pixel for displaying yellow for the right eye has been replaced with the arrangement of a sub-pixel (Lx1) for displaying yellow for the left eye and a sub-pixel (Rb1) for displaying blue for the right eye. Replacement with the sub-pixel and the sub-pixel and replacement with the sub-pixel and the sub-pixel are made for every other pixel.

### TECHNICAL FIELD

The present invention relates to an image display apparatus that three-dimensionally displays an image, and more specifically, an image display apparatus that expresses an image with four colors.

### BACKGROUND ART

An image display apparatus that uses a color filter of four colors adopts a stripe arrangement composed of four colors such as RGBW (red, green, blue, and white) or RGBY (red, green, blue, and yellow). In the stripe arrangement, a single pixel is made up of four sub-pixels (R, G, B, W/Y) arranged regularly in a horizontal direction. With an image display apparatus that three-dimensionally displays an image by using means for forming parallax (a parallax barrier method or a lenticular method, for example), sub-pixels for the left eye and sub-pixels for the right eye are arranged alternately to thereby realize a three-dimensional image display. The use of sub-pixels of four colors may enhance brightness but may also degrade image quality.

With regard to three-dimensional image displays, Japanese Patent Laying-Open No. 2008-191317 (PTD 1) and Japanese Patent Laying-Open No. 2008-191319 (PTD 2) disclose image processing apparatuses each capable of curtailing an amount of calculation required for image processing while reducing jaggies in an image contour (See [ABSTRACT]).

### CITATION LIST

### Patent Document

PTD 1: Japanese Patent Laying-Open No. 2008-191317

PTD 2: Japanese Patent Laying-Open No. 2008-191319

### SUMMARY OF INVENTION

### Technical Problem

However, with a display apparatus made up of four colors such as RGBW or RGBY, where the parallax barrier method for forming a stereoscopic display of a sub-pixel unit (a set of RGB will be referred to as a “pixel unit”, and a pigment unit of R/G/B will be referred to as a “sub-pixel unit”) is to be realized, if a stereoscopic display is formed by the same method as a sub-pixel method made up of the three colors of RGB, a three-dimensional image may not be visually recognized with correct colors. For example, since only red light and blue light enter the left eye, and only green light and yellow light enter the right eye, stereoscopic vision cannot be achieved with correct colors. There is, therefore, a need for a technology for suppressing degradation in the quality of a three-dimensionally displayed image.

The present invention was made to solve the problem as described above, and an object of the invention is to provide an image display apparatus in which degradation in the quality of a three-dimensionally displayed image has been suppressed.

### Solution to Problem

According to one aspect, an image display apparatus capable of three-dimensionally displaying an image includes parallax realizing means for outputting an image for a left eye and an image for a right eye of the image display apparatus, and a display device including a plurality of pixels. Each of the pixels has a plurality of sub-pixels. In each of alternate pixels of the plurality of pixels, an arrangement of a plurality of sub-pixels included in the pixel has been rearranged from an arrangement of a plurality of sub-pixels included in a pixel adjacent to the pixel.

Preferably, each of the pixels has, as sub-pixels of four colors, a first sub-pixel, a second sub-pixel, a third sub-pixel, and a fourth sub-pixel. An arrangement of the first sub-pixel and the second sub-pixel and an arrangement of the third sub-pixel and the fourth sub-pixel have been replaced in the alternate pixels.

Preferably, the parallax realizing means is configured to form a parallax barrier.

Preferably, the parallax realizing means includes a lenticular lens.

According to one aspect, degradation in the quality of a three-dimensionally displayed image can be suppressed.

The foregoing and other objects, features, aspects and advantages of the present invention will become more apparent from the following detailed description of the present invention when taken in conjunction with the accompanying drawings.

### BRIEF DESCRIPTION OF DRAWINGS

FIG. 1 is a diagram showing a portion of the configuration of a portable telephone 100, which is one embodiment of an image display apparatus having a color filter of three colors.

FIG. 2 is a diagram showing a portion of the configuration of a portable telephone 200, which is one embodiment of an image display apparatus having a color filter of four colors.

FIG. 3 is a block diagram showing a hardware configuration of portable telephone 100.

FIG. 4 is a diagram showing a portion of the configuration of an image display apparatus 400.

FIG. 5 is a diagram showing a variation of a color filter 500 of four colors.

FIG. 6 is a diagram showing variations of arrangements of color filters.

FIG. 7 is a diagram showing a portion of the configuration of an image display apparatus 800 according to another aspect.

### DESCRIPTION OF EMBODIMENTS

Embodiments of the present invention will be described hereinafter, with reference to the drawings. In the following description, the same reference signs denote the same components. The names and functions thereof are also the same. Detailed descriptions thereof will not therefore be repeated.

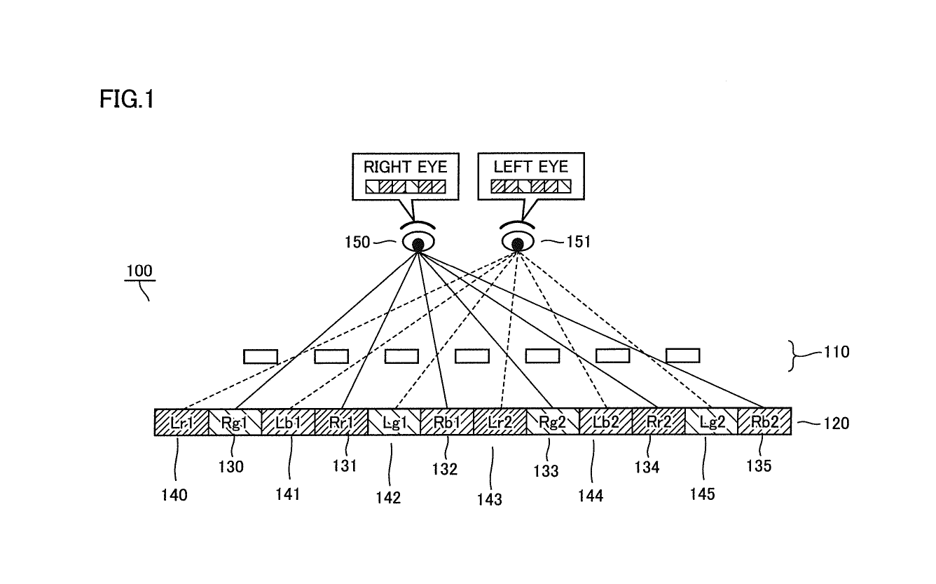

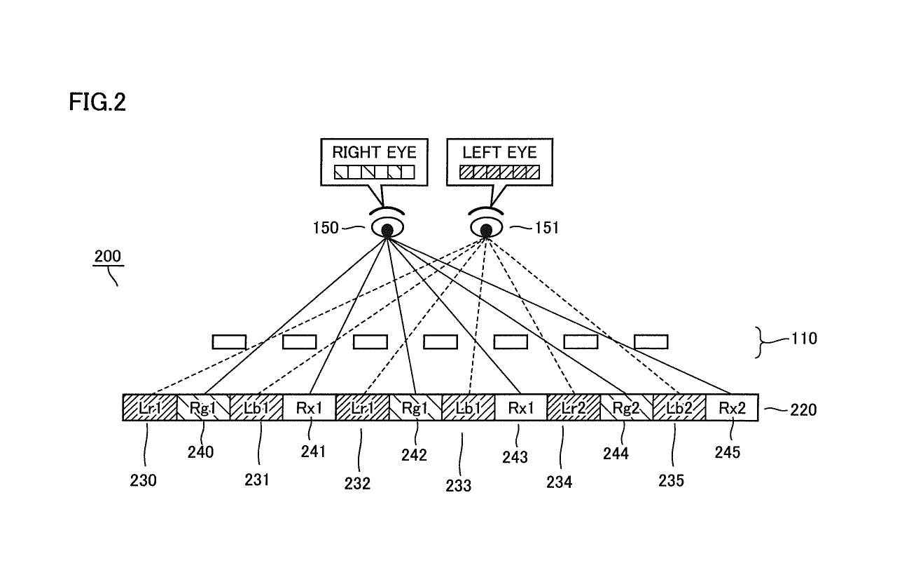

With reference to FIGS. 1 and 2, an arrangement of sub-pixels in an image display apparatus capable of three-dimensionally displaying an image will be described. FIG. 1 is a diagram showing a portion of the configuration of a portable telephone 100, which is one embodiment of an image display apparatus having a color filter of three colors.

In the present embodiment, portable telephone 100 is illustrated as one embodiment of the image display apparatus; however, the present invention can be applied to other electronic devices such as a PDA, an electronic dictionary, and other information processing terminals that are capable of three-dimensionally displaying an image.

Portable telephone 100 includes a barrier device 110 and a display device 120. Display device 120 includes a color filter of three colors (RGB). Barrier device 110 forms a parallax barrier or cancels the formation of the parallax barrier, in accordance with a command from a controller (not shown).

When an operation mode of portable telephone 100 is a three-dimensional display mode, barrier device 110 forms a parallax barrier. Light from sub-pixels 130, 131, 132, 133, 134, and 135 enters the right eye 150 of a user of portable telephone 100. Light from sub-pixels 140, 141, 142, 143, 144, and 145 enters the user's left eye 151. The user can thus recognize a three-dimensional image.

FIG. 2 is a diagram showing a portion of the configuration of a portable telephone 200, which is one embodiment of an image display apparatus having a color filter of four colors. Portable telephone 200 includes a barrier device 110 and a display device 220. Display device 220 includes the color filter of four colors (R, G, B, X). The color of color filter X is yellow, for example, although it is not limited thereto. With regard to color filter X hereinafter, yellow will be described as an example, unless otherwise stated.

When the operation mode of portable telephone 200 is the three-dimensional display mode, barrier device 110 forms a parallax barrier in the same manner as shown in FIG. 1. Light from sub-pixels 240, 241, 242, 243, 244, and 245 enters the right eye 150 of the user of portable telephone 200. Light from sub-pixels 230, 231, 232, 233, 234, and 235 enters the user's left eye 151. In this case, only the green light and the yellow light enter the right eye 150. Only the red light and the blue light enter the left eye 151. As a result, the user cannot visually recognize the three-dimensional image with correct colors.

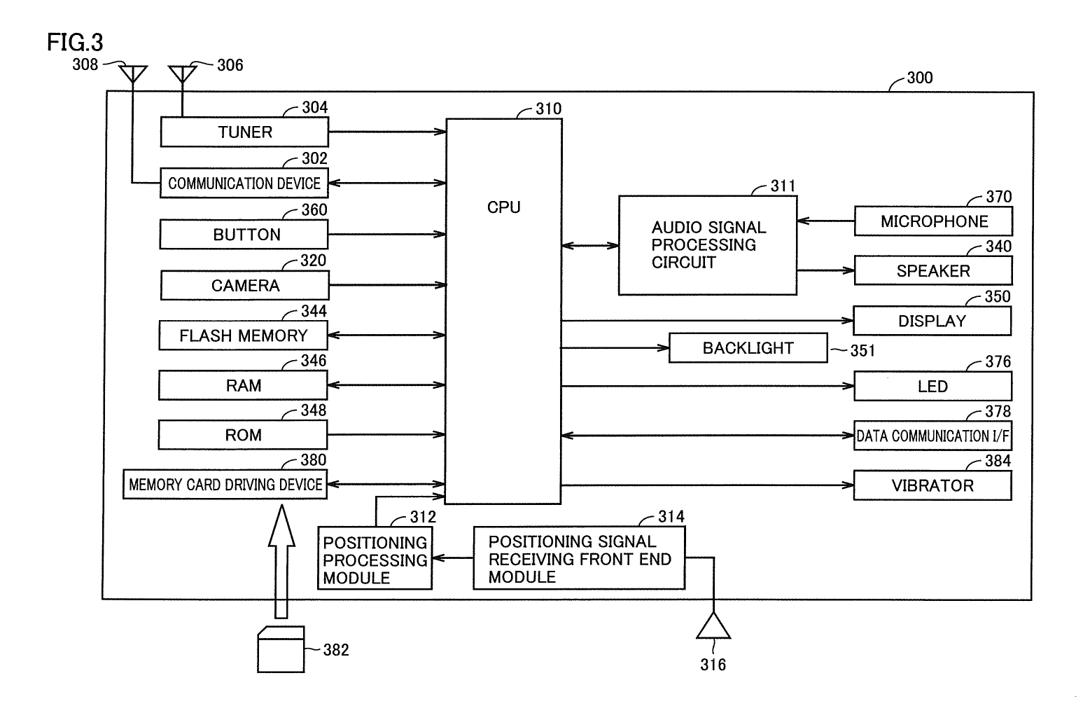

With reference to FIG. 3, a hardware configuration of portable telephone 100 according to the present embodiment will be described. FIG. 3 is a block diagram showing the hardware configuration of portable telephone 100. Portable telephone 100 includes a communication device 302, a tuner 304, antennas 306, 308, a CPU (Central Processing Unit) 310, an audio signal processing circuit 311, a positioning processing module 312, a positioning signal receiving front end module 314, a GPS (Global Positioning System) antenna 316, a camera 320, a speaker 340, a flash memory 344, a RAM (Random Access Memory) 346, a ROM (Read Only Memory) 348, a display 350, a backlight 351, a button 360, a microphone 370, an LED (Light Emitting Diode) 376, a memory card driving device 380, a data communication I/F (Interface) 378, and a vibrator 384. A memory card 382 can be inserted into memory card driving device 380.

Antenna 306 receives a television broadcasting signal. Tuner 304 selects a program in accordance with a command from CPU310, and transmits a video signal and an audio signal to CPU310.

A signal received by antenna 308 is subjected to front-end processing by communication device 302, and the processed signal is subsequently sent to CPU310. CPU310 executes processing for controlling the operation of portable telephone 100 based on a command issued to portable telephone 100. CPU310 executes predetermined processing based on a signal sent from communication device 302, and transmits the processed signal to audio signal processing circuit 311. Audio signal processing circuit 311 executes predetermined signal processing on the signal, and transmits the processed signal to speaker 340. Speaker 340 outputs a sound based on the signal.

Microphone 370 receives an utterance to portable telephone 100, and transmits a signal corresponding to the uttered voice to audio signal processing circuit 311. Audio signal processing circuit 311 executes predetermined processing for a telephone call based on the signal, and transmits the processed signal to CPU310. CPU310 converts the signal into data for transmission, and transmits the converted data to communication device 302. Communication device 302 generates a signal for transmission using the data, and transmits the signal toward antenna 308.

Flash memory 344 stores data sent from CPU310. CPU310 also retrieves data stored in flash memory 344, and executes predetermined processing using the data.

RAM346 temporarily holds data generated by CPU310 based on an operation performed on button 360. ROM348 stores a program or data for causing portable telephone 100 to execute a predetermined operation. CPU310 retrieves the program or data from ROM348, and controls the operation of portable telephone 100.

Memory card driving device 380 retrieves data stored in memory card 382, and transmits the data to CPU310. Conversely, memory card driving device 380 writes the data output from CPU310 to free space on memory card 382.

Audio signal processing circuit 311 executes the signal processing for a telephone call as described above. CPU310 and audio signal processing circuit 311 are depicted as separate components in the example shown in FIG. 3; however, in another aspect, CPU310 and audio signal processing circuit 311 may be integrally formed.

While display 350, in one aspect, is a touch panel display, a display other than a touch panel display may also be used. A mechanism for the touch panel is not particularly limited. Display 350 displays, based on data acquired from CPU 310, an image defined by the data. Display 350 displays a still picture, a moving picture, attributes of a music file (the name, the artist, the playing time, etc. of the file), and the like stored on flash memory 344.

Backlight 351 emits light toward display 350. In one aspect, backlight 351 increases or decreases the amount of light based on a control signal from CPU310.

LED376 realizes a predetermined light-emitting operation based on a signal from CPU310. When LED376 is capable of displaying a plurality of colors, for example, LED376 emits light of a color associated with data included in a signal output from CPU310. The mode of light emission (the interval, the number of emission colors, the flashing pattern, and the like) is not particularly limited.

A data communication I/F378 receives attachment of a cable for data communication. Data communication I/F378 transmits a signal output from CPU310 to the cable. Alternatively, data communication I/F378 transmits data received via the cable to CPU310.

Vibrator 384 executes an oscillating operation at a prescribed frequency based on a signal output from CPU310.

A GPS antenna 316 receives a signal sent from a GPS satellite, and transmits the received signal to positioning signal receiving front end module 314. Positioning signal receiving front end module 314 performs pattern matching based on each of at least three (desirably four or more) signals received from the GSP satellite, and, where a code pattern included in each signal matches a code pattern held by portable telephone 100, the signal is transmitted to positioning processing module 312.

Positioning processing module 312 performs positioning processing by using the signal to calculate a position of portable telephone 100 that has received the signal. CPU310 displays the result of calculation on display 350. In one aspect, display 350 may display position information (the latitude, the longitude, the altitude, and the like) of portable telephone 100 calculated by positioning processing module 312 over a map. In another aspect, display 350 may display an image of a place taken by camera 320 and the position information of the place over each other.

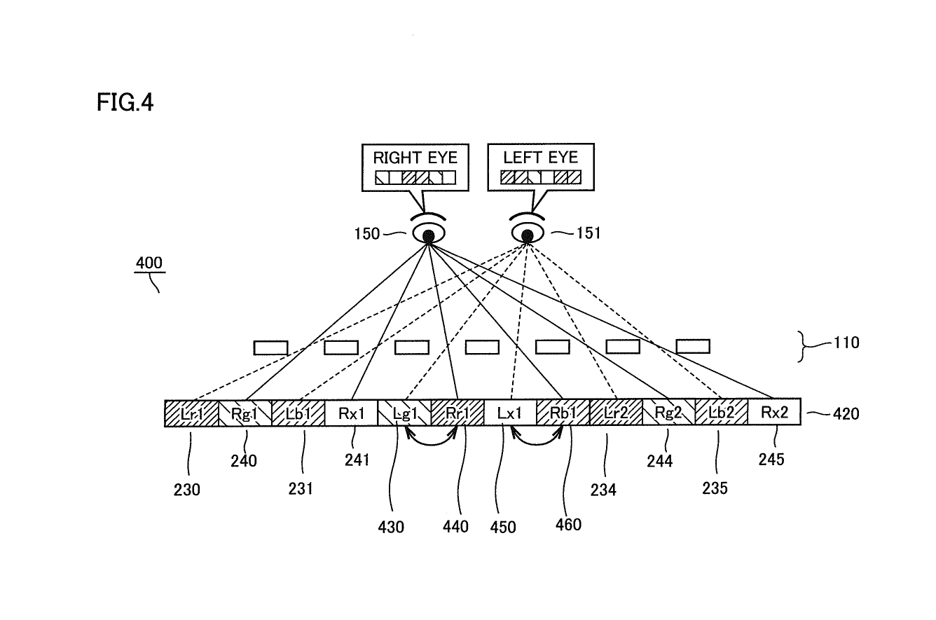

With reference to FIG. 4, the configuration of image display apparatus 400 according to the embodiment of the present invention will be described. FIG. 4 is a diagram showing a portion of the configuration of image display apparatus 400. Image display apparatus 400 includes a barrier device 110 and a display device 420.

Here, the arrangement of sub-pixel 430 and sub-pixel 440 and the arrangement of sub-pixel 450 and sub-pixel 460 are different from the arrangements shown in FIG. 2. Specifically, the arrangement of sub-pixel (Lr1) 232 for displaying red for left eye 151 and sub-pixel (Rg1) 242 for displaying green for right eye 150 shown in FIG. 2 has been replaced with the arrangement of sub-pixel (Lg1) 430 for displaying green for left eye 151 and sub-pixel (Rr1) 440 for displaying red for right eye 150, as shown in FIG. 4.

Similarly, the arrangement of sub-pixel (Lb1) 233 for displaying blue for left eye 151 and sub-pixel (Rx1) 243 for displaying yellow for right eye 150 shown in FIG. 2 has been replaced with the arrangement of sub-pixel (Lx1) 450 for displaying yellow for left eye 151 and sub-pixel (Rb1) 460 for displaying blue for right eye 150, as shown in FIG. 4.

The arrangement of sub-pixels shown in FIG. 4 is realized by forming the thus-arranged pigments on a filter surface. The arrangement of sub-pixels may be formed by printing, for example, but can also be formed by other methods.

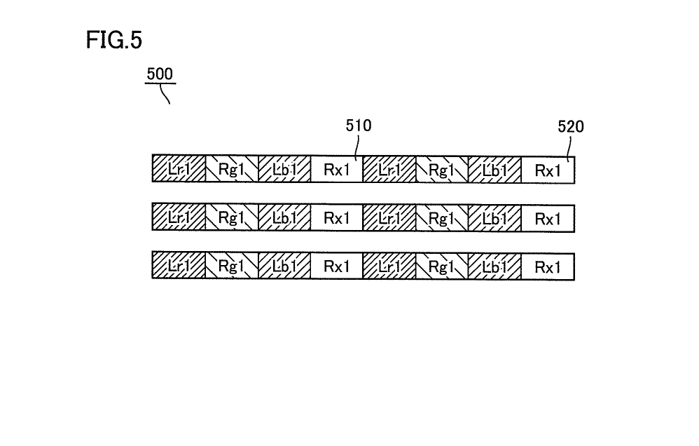

Now with reference to FIG. 5, the configuration of a color filter of four colors will be described. FIG. 5 is a diagram showing a variation of color filter 500 of four colors.

As shown in FIG. 5, color filter 500 of four colors has, in addition to red (r), green (g), and blue (b), filter portions 510, 520 of the fourth color. Any color may be used as the color of filter portions 510, 520, for example, white (w), yellow, (y), cyanogen (c), or the like. Color filter 500 of four colors is used to enhance brightness or color rendering properties.

When an image display apparatus three-dimensionally displays an image using a parallax barrier, brightness is sacrificed. An image display apparatus therefore desirably has a color filter of four colors.

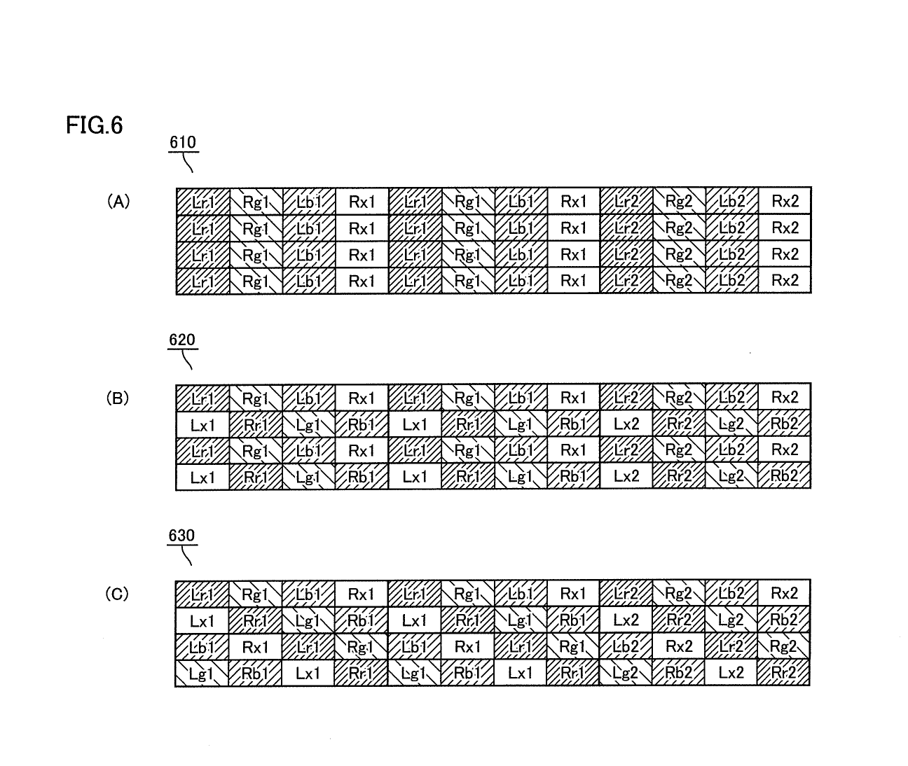

With reference to FIG. 6, arrangements of color filters will be described. FIG. 6 is a diagram showing variations of arrangements of color filters.

Pattern (A) shows color filter 610 having a stripe arrangement, as shown in FIG. 2. In this case, when the image display apparatus two-dimensionally displays an image, the resolution of the image is not sacrificed. However, as described with reference to FIG. 2, with this arrangement, the balance of left and right colors when an image is three-dimensionally displayed is impaired.

Pattern (B) displays color filter 620 whose arrangements have been rearranged. In this case, when a plurality of lines are visually recognized, left and right tones are satisfactory. However, when the image display apparatus two-dimensionally displays an image, the resolution of the image is sacrificed. For example, continuity of oblique green lines, vertical green lines, and the like is reduced.

Pattern (C) displays color filter 630 whose arrangements have been rearranged in another embodiment. In this case, when a plurality of lines are visually recognized, left and right tones are satisfactory. However, when the image display apparatus two-dimensionally displays an image, the resolution of the image is sacrificed. For example, continuity of vertical green lines and the like is reduced.

### Modifications

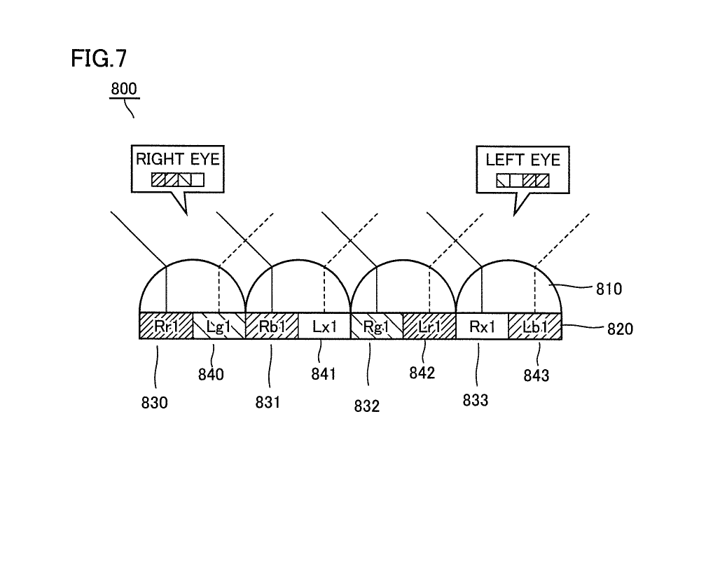

With reference to FIG. 7, a modification of the embodiment of the present invention will be described. FIG. 7 is a diagram showing a portion of the configuration of an image display apparatus 800 according to another aspect. Image display apparatus 800 includes a lenticular lens 810 and a display device 820, instead of a barrier device.

With this configuration, light from sub-pixels 830, 831, 832, and 833 enters the user's right eye, and light from sub-pixels 840, 841, 842, and 843 enters the left eye. Here, the arrangement of the colors of sub-pixels 830, 840, 831, and 841 is red (r), green (g), blue (b), and yellow (x). On the other hand, the arrangement of the colors of sub-pixels 832, 842, 833, and 843 has been replaced with the arrangement of green (g), red (r), yellow (x), and blue (b). This prevents a reduction in the color balance in the image display apparatus that uses a lenticular lens as well.

As described above, in the image display apparatus according to the embodiment of the present invention, in each of alternate pixels of a plurality of pixels, the arrangement of a plurality of sub-pixels included in the pixel has been rearranged from the arrangement of a plurality of sub-pixels included in a pixel adjacent to the pixel. Specifically, where each pixel has four sub-pixels, the arrangement of a first sub-pixel and a second sub-pixel and the arrangement of a third sub-pixel and a fourth sub-pixel have been replaced in alternate pixels.

Light that has passed through a color filter based on this arrangement enters the user's both eyes. With this arrangement, light of the same color enters both eyes, thereby preventing a reduction in the color balance.

Although this invention has been described in detail, it is clearly understood that the same is by way of illustration and example only and is not to be taken by way of limitation, the scope of the present invention being interpreted by the terms of the appended claims.

### REFERENCE SIGNS LIST

100, 200: portable telephone; 110: barrier device; 120, 220, 420, 820: display device; 150: right eye; 151: left eye; 340: speaker; 350: display; 360: button; 370: microphone; 302: communication device; 304: tuner; 306, 308, 316: antenna; 311: audio signal processing circuit; 312: positioning processing module; 314: positioning signal receiving front end module; 320: camera; 344: flash memory; 346: RAM; 348: ROM; 351: backlight; 378: data communication I/F; 380: memory card driving device; 382: memory card; 384: vibrator; 400, 700, 800: image display apparatus; 500, 610, 620, 630: color filter; 510, 520: filter portion; 810: lenticular lens.

1. An image display apparatus capable of three-dimensionally displaying an image comprising:
parallax realizing means for outputting an image for a left eye and an image for a right eye of said image display apparatus; and
a display device including a plurality of pixels, each of said pixels having a plurality of sub-pixels,
in each of alternate pixels of said plurality of pixels, an arrangement of a plurality of sub-pixels included in the pixel being rearranged from an arrangement of a plurality of sub-pixels included in a pixel adjacent to the pixel.

2. The image display apparatus according to claim 1, wherein
each of said pixels has, as sub-pixels of four colors, a first sub-pixel, a second sub-pixel, a third sub-pixel, and a fourth sub-pixel, and
an arrangement of said first sub-pixel and said second sub-pixel and an arrangement of said third sub-pixel and said fourth sub-pixel have been replaced in said alternate pixels.

3. The image display apparatus according to claim 1, wherein
said parallax realizing means is configured to form a parallax barrier.

4. The image display apparatus according to claim 1, wherein
said parallax realizing means includes a lenticular lens.
